(19) United States
(12) Patent Application Publication
(10) Pub. No.: US 2008/0303808 A1
(43) Pub. Date: Dec. 11, 2008

(54) Liquid crystal display with flicker reducing circuit and driving method thereof

(75) Inventor: Shun-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY(SHENZHEN) CO., LTD.; INNOLUX DISPLAY CORP.

(21) Appl. No.: 12/157,022

(22) Filed: Jun. 6, 2008

(30) Foreign Application Priority Data
Jun. 8, 2007 (CN) 200710074775.3

(51) Int. Cl. G09G 5/00; G09G 3/36

(52) U.S. Cl. 345/214; 345/87; 345/99

(57) ABSTRACT

An exemplary liquid crystal display includes an image signal analyzing circuit, a frame rate controlling circuit, an image signal processing circuit, and an output circuit. The image signal analyzing circuit is configured for judging whether images corresponding to input signals have flicker by analyzing pixel intensities and pixel voltage polarities of the input signals of each frame, and outputting controlling signals. The frame rate controlling circuit is configured for controlling a frame rate of output signals according to the controlling signals received from the image signal analyzing circuit. The image signal processing circuit is configured for inserting black image signals into input signals if the images corresponding to input signals have flicker. The output circuit is configured for outputting image signals according to signals transmitted from the frame rate controlling circuit and the image signal processing circuit.

### FIELD OF THE INVENTION

The present invention relates to a liquid crystal display (LCD) with a flicker reducing circuit, and to a method of driving the LCD.

### GENERAL BACKGROUND

A typical LCD has the advantages of portability, low power consumption, and low radiation. Therefore, the LCD has been widely used in various portable information products, such as notebooks, personal digital assistants (PDAs), video cameras, and the like. When a direct pixel voltage is applied to a liquid crystal layer of the LCD for an extended period, liquid crystal molecules in the liquid crystal layer are liable to deteriorate. Thus, it is preferable to change a polarity of the pixel voltages with each successive frame of images displayed. Usually, the pixel voltages have a positive polarity and a negative polarity. Methods of driving a typical LCD are generally classified into a frame inversion driving method, a row inversion driving method, a column inversion driving method, and a dot inversion driving method. The methods differ one from another according to the polarity pattern of the pixel voltages in a frame.

FIG. 5 shows polarity patterns of pixel voltages in two successive frames of a typical LCD employing the dot inversion driving method. In an exemplary frame N, the polarity of each pixel voltage is different from that of four adjacent pixel voltages, as viewed along both the column direction and the row direction. In an exemplary next frame N+1, the polarities of all the pixel voltages are inverted.

Referring also to FIG. 6, this shows patterns of pixel characteristics in two successive frames of the LCD employing the dot inversion driving method. “0” represents a pixel having a pixel intensity lower than a reference value. The pixel intensity is controlled by the pixel voltage. “1+” represents a pixel that has a pixel intensity greater than the reference value and that has a positive pixel voltage polarity. “1−” represents a pixel that has a pixel intensity greater than the reference value and that has a negative pixel voltage polarity.

When the LCD displays certain images, in an exemplary frame N, some pixels having pixel intensities lower than the reference value are represented as “0”, and all the other pixels having pixel intensities greater than the reference value are represented as “1+”. In an exemplary next frame N+1, the pixels that have pixel intensities lower than the reference value are also represented as “0”, and all the other pixels having pixel intensities greater than the reference value are represented as “1−”. That is, between the frames N and N+1, the polarities of the pixel voltages are converted between “1+” and “1−”. Typically, a frame rate of the LCD is 60 Hz. Therefore, the polarity conversion rate of the pixel voltages is 60/2=30 Hz. As a result, flickering is liable to be visible when the corresponding images are displayed by the LCD. That is, if the flickering rate is as little as 30 Hz, the human eye can easily perceive the flickering of the images displayed by the LCD. Thus, the display characteristics and performance of the LCD are reduced.

What are needed, therefore, are a liquid crystal display and a driving method for driving the liquid crystal display which can overcome the above-described deficiencies.

### SUMMARY

An exemplary liquid crystal display includes an image signal analyzing circuit, a frame rate controlling circuit, an image signal processing circuit, and an output circuit. The image signal analyzing circuit is configured for judging whether images corresponding to input signals have flicker by analyzing pixel intensities and pixel voltage polarities of the input signals of each frame, and outputting controlling signals. The frame rate controlling circuit is configured for controlling a frame rate of output signals according to the controlling signals received from the image signal analyzing circuit. The image signal processing circuit is configured for inserting black image signals into input signals if the images corresponding to input signals have flicker. The output circuit is configured for outputting image signals according to signals transmitted from the frame rate controlling circuit and the image signal processing circuit.

A method for driving a liquid crystal display, the method includes the following steps: inputting signals to the liquid crystal display; judging whether images corresponding to the input signals have flicker by analyzing pixel intensities and pixel voltage polarities of each frame displayed by the liquid crystal display; generating a controlling signal according to the result of judgment; controlling a frame rate of output signals according to the controlling signals by a frame rate controlling circuit of the liquid crystal display; inserting black image signals into input signals by an image signal processing circuit of the liquid crystal display, if the images corresponding to input signals have flicker; and outputting image signals according to signals transmitted from the frame rate controlling circuit and the image signal processing circuit.

Other novel features and advantages will become more apparent from the following detailed description when taken in conjunction with the accompanying drawings.

### BRIEF DESCRIPTION OF THE DRAWINGS

FIG. 1 is an abbreviated block diagram showing certain components of a liquid crystal display according to a first embodiment of the present invention, the liquid crystal display including a flicker reducing circuit.

FIG. 2 is a block diagram of the flicker reducing circuit of FIG. 1.

FIG. 3 is a timing chart illustrating exemplary operation of the liquid crystal display of FIG. 1.

FIG. 4 is an abbreviated block diagram showing certain components of a liquid crystal display according to a second embodiment of the present invention.

FIG. 5 shows polarity patterns of pixel voltages in two successive frames of a conventional liquid crystal display employing a dot inversion driving method.

FIG. 6 shows patterns of pixel characteristics in two successive frames of the liquid crystal display of FIG. 5 employing the dot inversion driving method.

### DETAILED DESCRIPTION OF PREFERRED EMBODIMENTS

Reference will now be made to the drawings to describe preferred and exemplary embodiments in detail.

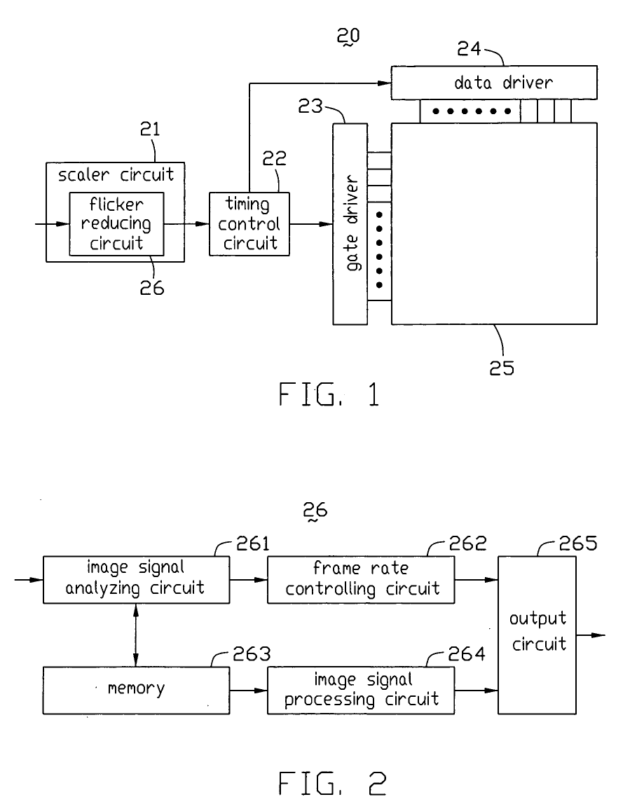

FIG. 1 is an abbreviated block diagram showing certain components of an LCD 20 according to a first embodiment of the present invention. The LCD 20 includes a liquid crystal display panel 25, a data driver 24 configured for driving data lines (not labeled) of the liquid crystal display panel 25, a gate driver 23 configured for driving gate lines (not labeled) of the liquid crystal display panel 25, a timing control circuit 22, and a scaler circuit 21. The timing control circuit 22 is configured for providing clock signals to the gate driver 23 and the data driver 24. The scaler circuit 21 is connected to the timing control circuit 22, and is configured for processing image signals. The scaler circuit 21 includes a flicker reducing circuit 26.

Referring also to FIG. 2, this is a block diagram of the flicker reducing circuit 26. The flicker reducing circuit 26 includes an image signal analyzing circuit 261, a frame rate controlling circuit 262, a memory 263, an image signal processing circuit 264, and an output circuit 265. In the present embodiment, the image signal analyzing circuit 261, the frame rate controlling circuit 262, the memory 263, the image signal processing circuit 264, and the output circuit 265 are integrated in the scaler circuit 21 as a single component. The image signal analyzing circuit 261 is connected to the output circuit 265 via the frame rate controlling circuit 262. An input terminal (not labeled) of the memory 263 is connected to the image signal analyzing circuit 261, and an output terminal (not labeled) of the memory 263 is connected to the output circuit 265 via the image signal processing circuit 264.

The image signal analyzing circuit 261 is configured for judging whether images corresponding to input signals have flicker by analyzing pixel intensities and pixel voltage polarities of each frame. The frame rate controlling circuit 262 is configured for controlling the frame rate of image signals outputted by the output circuit 265. In the present embodiment, the frame rate controlling circuit 262 controls the LCD 20 to display images having a frame rate of 60 Hz or 75 Hz according to need. The memory 263 is configured for storing image signals. The image signal processing circuit 264 is configured for inserting black image signals into the input image signals if the images corresponding to the input image signals have flicker. The output circuit 265 is configured for outputting image signals according to signals transmitted from the frame rate controlling circuit 262 and the image signal processing circuit 264.

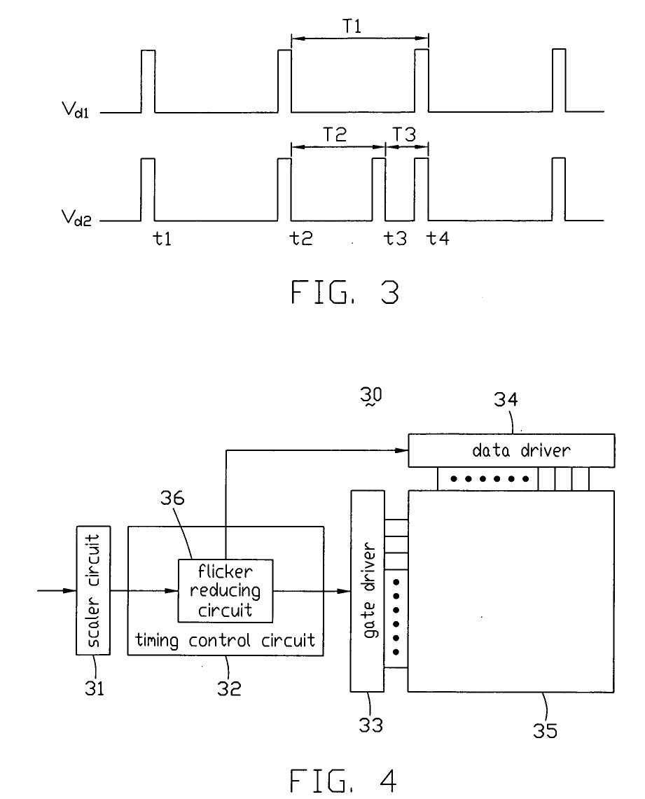

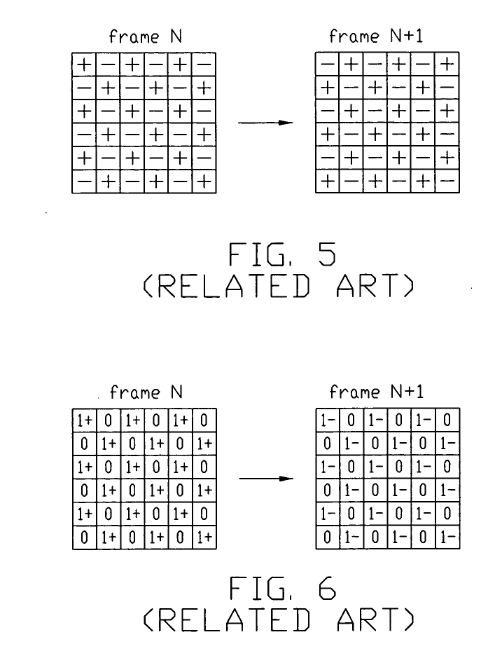

Referring also to FIG. 3, this is a timing chart illustrating exemplary operation of the LCD 20. “Vd1” represents image signals inputted to the image signal analyzing circuit 261. “Vd2” represents image signals outputted by the output circuit 265. In operation, image signals corresponding to a frame N are stored in the memory 263 via the image signal analyzing circuit 261. The image signals can be video graphics array (VGA) signals or digital visual interface (DVI) signals. The frame rate of the images corresponding to the input image signals is 60 Hz.

During a period from t1 to t2, the image signals stored in the memory 263 are transmitted to the image signal analyzing circuit 261. The image signal analyzing circuit 261 analyzes the pixel intensities and the pixel voltage polarities of the frame N. In the present embodiment, the pixel voltage controls the pixel intensity. If pixel voltage polarities of the pixels that have pixel intensities greater than a reference value are not the same, the image signal analyzing circuit 261 outputs a controlling signal to the frame rate controlling circuit 262. According to the controlling signal, the frame rate controlling circuit 262 controls the output circuit 265 to output image signals having a frame rate of 60 Hz.

Simultaneously, image signals corresponding to a next frame N+1 are stored in the memory 263 via the image signal analyzing circuit 261. The image signals corresponding to the frame N are transmitted to the output circuit 265 via the image signal processing circuit 264. Thereby, the output circuit 265 outputs image signals according to signals transmitted from the frame rate controlling circuit 262 and the image signal processing circuit 264. The image signals outputted by the output circuit 265 can be low voltage differential signals (LVDS) or reduced swing differential signals (RSDS). The frame rate of the displayed images corresponding to the image signals outputted by the output circuit 265 is 60 Hz.

The timing control circuit 22 receives image signals outputted by the output circuit 265. According to the image signals, the timing control circuit 22 outputs data signals to the data driver 24 and clock signals to both the data driver 24 and the gate driver 23. Thereby, the data driver 24 and the gate driver 23 drive the liquid crystal display panel 25 to display images.

During a period from t2 to t4, the image signals corresponding to the frame N+1 are transmitted to the image signal analyzing circuit 261 from the memory 263. The image signal analyzing circuit 261 analyzes the pixel intensities and the pixel voltage polarities of the frame N+1. If pixel voltage polarities of the pixels that have pixel intensities greater than the reference value are the same, the image signal analyzing circuit 261 outputs another controlling signal to the frame rate controlling circuit 262. According to the controlling signal, the frame rate controlling circuit 262 controls the output circuit 265 to output image signals having a frame rate of 75 Hz. That is, the frame period of each frame is decreased from T1 to T2.

The image signal processing circuit 264 receives the image signals corresponding to the frame N+1 from the memory 263. During a period from t3 to t4, black image signals corresponding to black images are inserted into the image signals received from the memory 263. The period of the black images is T3, where T1=T2+T3. The signals outputted by the image signal processing circuit 264 are transmitted to the output circuit 265. Thereby, the output circuit 265 outputs image signals according to signals transmitted from the frame rate controlling circuit 262 and the image signal processing circuit 264. As a result, the frame rate of the displayed images corresponding to the image signals outputted by the output circuit 265 is increased to 75 Hz, and black images are inserted into the displayed images of the LCD 20.

The timing control circuit 22 receives image signals outputted by the output circuit 265. According to the image signals, the timing control circuit 22 outputs data signals to the data driver 24 and clock signals to both the data driver 24 and the gate driver 23. Thereby, the data driver 24 and the gate driver 23 drive the liquid crystal display panel 25 to display images.

As detailed above, the scaler circuit 21 includes the flicker reducing circuit 26. The flicker reducing circuit 26 includes the image signal analyzing circuit 261 for analyzing the pixel intensities and the pixel voltage polarities of each frame. In each frame, if the pixel voltage polarities of the pixels that have pixel intensities greater than the reference value are the same, the frame rate corresponding to the image signals outputted by the flicker reducing circuit 26 is increased to 75 Hz. As a result, the polarity conversion rate of the data voltages, of the LCD 20 is increased to a value above 30 Hz. Thereupon, the human eye cannot easily perceive the flickering of the corresponding images displayed by the LCD 20. Thus, the display characteristics and performance of the LCD 20 are improved.

Furthermore, if the images displayed by the LCD 20 exhibit little or no flicker, the frame rate of the images is 60 Hz. If the flicker of the images displayed by the LCD 20 is judged by the image signal analyzing circuit 261 to be obvious, the frame rate of the images is increased to 75 Hz and black images are inserted into the images. This means the power consumption of the LCD 20 is reduced compared with an LCD that constantly employs a frame rate of 75 Hz.

FIG. 4 is an abbreviated block diagram showing certain components of an LCD 30 according to a second embodiment of the present invention. The LCD 30 has a structure similar to that of the LCD 20. However, the LCD 30 includes a scaler circuit 31, a timing control circuit 32, a gate driver 33, a data driver 34, and a liquid crystal display panel 35. The timing control circuit 32 includes a flicker reducing circuit 36. The flicker reducing circuit 36 has substantially the same characteristics and functions as described above in relation to the flicker reducing circuit 26.

Various modifications and alterations of the above-described embodiments are possible. For example, the flicker reducing circuit 26 can be a discrete circuit connected between the scaler circuit 21 and the timing control circuit 22. In another example, if the images displayed by the LCD 20 have flicker, a frame rate of the images can be increased to a level above 75 Hz, such as 80 Hz or even 120 Hz.

It is to be further understood that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
an image signal analyzing circuit configured for judging whether images corresponding to input signals have flicker by analyzing pixel intensities and pixel voltage polarities of the input signals of each frame, and outputting controlling signals according to a result of the judgment;
a frame rate controlling circuit configured for controlling a frame rate of output signals according to the controlling signals received from the image signal analyzing circuit;
an image signal processing circuit configured for inserting black image signals into the input signals if the images corresponding to the input signals have flicker; and
an output circuit configured for outputting image signals according to signals transmitted from the frame rate controlling circuit and the image signal processing circuit.

2. The liquid crystal display of claim 1, further comprising a memory configured for storing signals, wherein the image signal analyzing circuit and the image signal processing circuit are configured to receive signals from the memory.

3. The liquid crystal display of claim 1, wherein a frame rate of the input signals is 60 Hz.

4. The liquid crystal display of claim 1, wherein if a plurality of the image signals have pixel intensities greater than a reference value and if pixel voltage polarities of such plurality of image signals are the same in a frame, the frame rate controlling circuit outputs controlling signals to increase the frame rate of the output signals.

5. The liquid crystal display of claim 4, wherein the frame rate of the output signals is increased from 60 Hz to 75 Hz.

6. The liquid crystal display of claim 1, wherein if a plurality of the input signals have pixel intensities greater than a reference value and if pixel voltage polarities of any of such plurality of image signals are different in a frame, the frame rate controlling circuit outputs controlling signals such that a frame rate of the output signals is a predetermined normal frame rate.

7. The liquid crystal display of claim 6, wherein the predetermined normal frame rate is 60 Hz.

8. The liquid crystal display of claim 1, wherein the input signals are video graphics array signals.

9. The liquid crystal display of claim 1, wherein the output signals are low voltage differential signals.

10. The liquid crystal display of claim 1, further comprising a scaler circuit configured for processing image signals, wherein the image signal analyzing circuit, the frame rate controlling circuit, the image signal processing circuit, and the output circuit are integrated in the scaler circuit as a single component.

11. The liquid crystal display of claim 10, further comprising a timing control circuit connected to the scaler circuit, wherein the timing control circuit is configured for generating clock signals.

12. The liquid crystal display of claim 11, further comprising a data driver, a gate driver, and a liquid crystal display panel, wherein the data driver and the gate driver drive the liquid crystal display panel according to the clock signals received from the timing control circuit.

13. A method for driving a liquid crystal display, the method comprising:
inputting signals to the liquid crystal display;
judging whether images corresponding to the input signals have flicker by analyzing pixel intensities and pixel voltage polarities of each frame;
generating a controlling signal according to the judging result;
controlling a frame rate of output signals according to the controlling signals by a frame rate controlling circuit of the liquid crystal display;
inserting black image signals into input signals by an image signal processing circuit of the liquid crystal display, if the images corresponding to the input signals have flicker; and
outputting image signals according to signals transmitted from the frame rate controlling circuit and the image signal processing circuit.

14. The method of claim 13, wherein if a plurality of the image signals have pixel intensities greater than a reference value and if pixel voltage polarities of such plurality of image signals are the same in a frame, the frame rate controlling circuit outputs controlling signals to increase the frame rate of the output signals.

15. The method of claim 14, wherein a frame rate of the input signals is 60 Hz.

16. The method of claim 15, wherein the frame rate of the output signals is increased from 60 Hz to 75 Hz.

17. The method of claim 13, wherein if a plurality of the input signals have pixel intensities greater than a reference value and if pixel voltage polarities of any of such plurality of image signals are different in a frame, the frame rate controlling circuit outputs controlling signals such that a frame rate of the output signals is a predetermined normal frame rate.

18. The method of claim 17, wherein the predetermined normal frame rate is 60 Hz.
